(19) United States
(12) Patent Application Publication
(10) Pub. No.: US 2009/0211825 A1
(43) Pub. Date: Aug. 27, 2009

(54) Method for Operating a Combustion Engine

(75) Inventors: Karsten Mann, Stuttgart (DE); Markus Hernier, Gerlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/084,071

(22) PCT Filed: Sep. 18, 2006
(86) PCT No.: PCT/EP2006/066454

§ 371 Date: Mar. 11, 2009

(30) Foreign Application Priority Data
Oct. 25, 2005 (DE) 10 2005 051 002.7

(51) Int. Cl. B60W 10/04; F02D 41/00; F02B 3/00; F02B 63/00; B60W 20/00

(52) U.S. Cl. 180/65.275; 123/672; 123/299; 123/2; 180/65.21

(57) ABSTRACT

A method for operating a combustion engine, in which at least one electric motor for providing drive assistance is activated at least intermittently in a normal driving mode having a requested drive power. It is provided that the combustion engine is operated selectively in steady-state or dynamic fashion as a function of a selected combustion process.

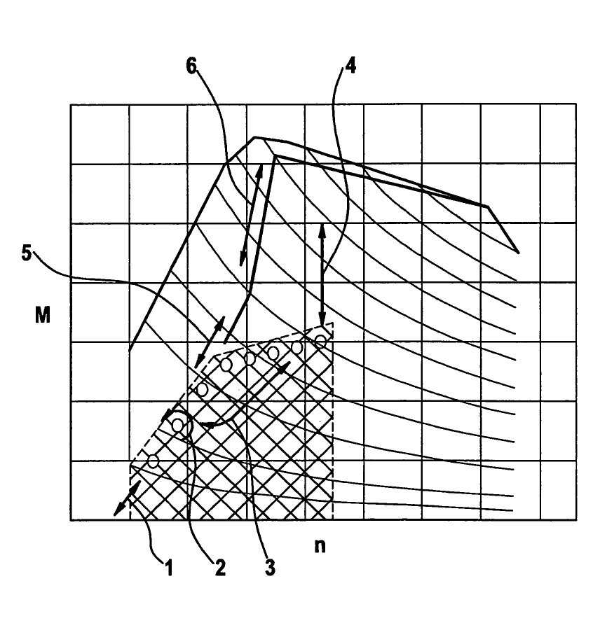

### FIELD OF THE INVENTION

The present invention is based on a method for operating a combustion engine.

### BACKGROUND INFORMATION

Hybrid vehicles, in which combustion engines and electric motors interact in the drive train are well-known. Various systems are familiar, such as serial hybrids in which the combustion engine is not connected mechanically to the drive wheels, parallel hybrids, in which the combustion engine and the electric motor (or perhaps several electric motors) are connected mechanically to the drive wheels, as well as mixed forms, e.g., power-split hybrids, in which the combustion engine is both connected mechanically to the drive wheels and also drives the electric motor.

International Patent Application No. WO 2005/012022 discusses a method for operating a hybrid vehicle having a diesel engine, in which an electric motor assists the diesel engine when the gears are shifted and the clutch is disengaged. The method is used to improve the efficiency of the drive and to reduce emissions at low speeds of the diesel engine.

### SUMMARY OF THE INVENTION

A method according to the present invention is provided for operating a combustion engine, in which at least one electric motor for providing drive assistance is activated at least intermittently in a normal driving mode having a requested drive power, and in which the combustion engine is operated selectively in steady-state or dynamic fashion as a function of a selected combustion process. An advantageously low-emission operation of the combustion engine is possible when a particularly low-emission combustion process can be selected which, to be sure, exhibits a poor dynamic performance, e.g., upon engine-load alternation; however, the electric motor is able to provide the dynamic power components of the drive with high dynamic performance. This can be advantageous in load ranges in which different combustion processes cause different amounts of emissions. The electric motor makes it possible to select an optimal combustion process for the specific load range. One electric motor, or perhaps two or more electric motors may be used. The combustion process of the combustion engine may be changed in different load ranges. The combustion engine is preferably operated selectively in serial or in parallel or in parallel-serial or in power-split mode with the aid of two electric motors. The combustion engine is thereby operated with a favorable combustion process depending on the power requirement.

In one advantageous method operation, during steady-state operation of the combustion engine, a dynamic power component of the requested drive power may be provided by electric motor. The combustion engine feeds its power output into an energy store, e.g., a battery, from which the electric motor takes its drive energy as a function of a requested drive power and dynamic performance. The combustion engine is operated in a favorable range having optimized operating parameters for reducing unwanted emissions, e.g., soot and nitrogen oxides in the case of diesel engines.

In a further advantageous method operation, in dynamic operation, the combustion engine generates at least a portion of the dynamic power component. The furnishing of the power components by electric motor and combustion engine may be optimized with respect to the emissions of the combustion engine here, as well.

The combustion process with which the combustion engine is operated may be selected as a function of emissions of the combustion engine.

In another advantageous method operation, in steady-state operation, a total fuel quantity needed for a specific engine cycle is injected directly into a combustion chamber of the combustion engine and thereupon ignited. In the case of diesel engines, particularly in the part-load range, a “homogeneous” diesel combustion is used with special advantage (HCCI=homogeneous charge compression ignition), which leads to a combustion extremely low in soot and nitrogen oxides. In the HCCI operating mode, the diesel fuel is injected directly into a combustion chamber of the diesel engine, and the fuel-air mixture developing in the combustion chamber is only ignited when the total fuel quantity needed for the engine cycle in question has been injected into the respective combustion chamber.

The “(p)HCCI” (partly homogeneous charge compression ignition) combustion process, in which only very small quantities of fuel are injected into the combustion chamber after the ignition, represents an intermediate stage. Lower emissions are obtained than when using the conventional combustion process in this case, as well. In the HCCI combustion process, it is assumed that the fuel in the combustion chamber is homogenized prior to the ignition, while in the (p)HCCI combustion process, the fuel is partially injected and homogenized prior to the ignition, and is partially first injected into the combustion chamber after the ignition. Expediently, both combustion processes will occur at different operating points in an engine application. In this context, preferably the transitions between the combustion processes are fluid, so that the two combustion processes are treated as virtually equivalent.

In the HCCI or (p)HCCI operating mode, the combustion engine may be operated respectively in a steady-state or quasi steady-state manner. In the quasi steady-state operation, the combustion engine carries out only slow operating-point changes. In that case, the dynamic power component of the drive is provided by the electric motor. In a conventional combustion process of the diesel engine, in dynamic operation, fuel is injected into the combustion chamber even after ignition has begun. This combustion process may be used in different load ranges.

In a further advantageous method operation, to adjust an increased power output in steady-state operation of the combustion engine, it is not fired for a brief time and is pulled by the electric motor to a new operating point. While the combustion engine is being pulled, preferably an air-side charge cycle of the combustion air of the combustion engine is optimized for the new operating point. In the case of a diesel engine, it may also be operated at the new operating point with parameters favorable for the HCCI operation or (p)HCCI operation.

In another advantageous method operation, the combustion engine is operated in quasi steady-state to set an increased power output. In this case, only highly dynamic motive components are compensated for by the electric motor in the HCCI or (p)HCCI operating mode. Preferably, the steady-state or quasi steady-state operation of the combustion engine is set in a part-load range of the combustion engine, while the dynamic operation of the combustion engine is set in a high-load range and/or full-load range and/or at high speeds of the combustion engine.

In a hybrid vehicle according to the present invention having at least one combustion engine, where at least one electric motor for providing drive assistance is able to be activated at least intermittently in a normal driving mode having a requested drive power, the dynamic operation of the combustion engine is set in a high-load range and/or full-load range and/or at high speeds of the combustion engine.

Further specific embodiments, aspects and advantages of the present invention are also yielded, regardless of their combination in claims and without restricting the generality, from an exemplary embodiment of the invention described in the following with reference to the drawing.

### BRIEF DESCRIPTION OF THE DRAWING

The FIGURE shows a characteristics field of a combustion engine with torque over the speed of the combustion engine for the case of a diesel engine.

### DETAILED DESCRIPTION

The FIGURE shows a characteristics field having torque characteristics M of a combustion engine over its speed n based on a diesel engine of a preferred hybrid vehicle whose total drive train is set up and operated in such a way that emissions such as CO₂, nitrogen oxides and soot exhausted by the combustion engine are as minimal as possible.

The diesel engine is preferably operated selectively in serial or in parallel or in parallel-serial or in power-split mode with the aid of two electric motors. To that end, a design known per se, having a parallel hybrid including two electric motors and having a torque converter lockup clutch, is favorable.

In this context, the diesel engine is operated either in HCCI operating mode or (p)HCCI operating mode or in conventional mode, depending on the required power output. At the same time, at least one electric motor with high dynamics makes drive energy available for boosting the vehicle. In the (p)HCCI operating mode, the drive corresponds to that of a parallel hybrid drive.

In the (p)HCCI process, the diesel fuel is injected directly into a combustion chamber of the diesel engine, and the fuel-air mixture developing in the combustion chamber is only ignited when virtually the total fuel quantity needed for the engine cycle in question has been injected into the respective combustion chamber. Only a small quantity of fuel is still injected after the ignition.

The hatched area is intended to indicate the area in which the diesel engine is running in steady-state operation in the HCCI operating mode, and the dynamic performance of the drive train is improved by electromotive assistance. Since the HCCI combustion process is controlled on the combustion-air side, the dynamics with respect to the combustion of the fuel, especially during an engine load change, are restricted. Moreover, the special mixture formation, particularly in the part-load range, must be produced with sufficient reliability.

In the high-load range, full-load range and/or at high engine speeds, the diesel engine is operated with a conventional combustion process, in which fuel is still injected after the beginning of the combustion of the fuel in the combustion chamber.

Moreover, a rapid transition may be achieved between the operating mode using the (p)HCCI combustion process and the conventional combustion process, in that the diesel engine is pulled to a suitable operating point by the electric motor.

Preferably an electric motor having 20 to 50 kW is used for an automobile.

Area 1 in the FIGURE indicates that HC and CO emissions may be prevented by the parallel hybrid drive in the quasi steady-state (p)HCCI operating mode of the diesel engine at low exhaust-gas temperatures, as a result of a low torque at low speed of the diesel engine. Area 2 indicates that the dynamic performance may be improved by using the electric motor in the HCCI operating mode of the diesel engine. Area 3 in the FIGURE indicates that the operating point of the diesel engine in the HCCI operating mode may be switched by the electric motor in that it pulls the diesel engine, that is, in which in the (p)HCCI operating mode, the combustion engine effects slow changes of the operating point. Area 4 indicates how the electric motor is able to improve the power output of the drive train while the diesel engine is running in the (p)HCCI operating mode with favorable emission behavior. Area 5 indicates how the transition between operation with the (p)HCCI combustion process and the conventional combustion process is improved. In this context, operation of the diesel engine with the lowest emissions may be achieved in each instance by the (p)HCCI operating mode.

In area 6, the diesel engine is operated with a conventional combustion process, the electric motor assisting the diesel engine so that it is able to run with optimized parameters. Advantageously, it follows here that the energy store is small, since only boost functions are assisted electromotively. A battery with 0.5-1 kWh may be sufficient for the electric motor having 20-50 kW.

1-11. (canceled)

12. A method for operating a combustion engine, the method comprising:
activating at least one electric motor for providing drive assistance at least intermittently in a normal driving mode having a requested drive power; and
selectively operating the combustion engine in a steady-state, a quasi steady-state or dynamically as a function of a selected combustion process.

13. The method of claim 12, wherein during a steady-state operation of the combustion engine, a dynamic power component of the requested drive power is provided by an electric motor.

14. The method of claim 12, wherein in a dynamic operation, the combustion engine generates at least a portion of a dynamic power component.

15. The method of claim 12, wherein the combustion process is selected as a function of emissions of the combustion engine.

16. The method of claim 12, wherein in a steady-state operation, a total fuel quantity needed for a specific engine cycle is injected directly into a combustion chamber of the combustion engine, and thereupon ignited.

17. The method of claim 16, wherein in a dynamic operation, fuel is injected into the combustion chamber even after ignition has begun.

18. The method of claim 12, wherein to set an increased power output in a steady-state operation, the combustion engine is not fired for a brief time, and is pulled by the electric motor to a new operating point.

19. The method of claim 18, wherein while the combustion engine is being pulled, an air-side charge cycle of the combustion air of the combustion engine is optimized for the new operating point.

20. The method of claim 12, wherein the steady-state operation of the combustion engine is set in a part-load range of the combustion engine.

21. The method of claim 12, wherein the dynamic operation of the combustion engine is set in at least one of a high-load range, a full-load range, and at high speeds of the combustion engine.

22. A hybrid vehicle having at least one combustion engine, comprising:
at least one electric motor for providing drive assistance, and which is activatable at least intermittently in a normal driving mode having a requested drive power; and
setting a dynamic operation of the combustion engine in at least one of a high-load range, a full-load range, and at high speeds of the combustion engine.
